(19) United States
(12) Patent Application Publication
(10) Pub. No.: US 2024/0332597 A1
(43) Pub. Date: Oct. 3, 2024

(54) BATTERY MODULE

(71) Applicant: HONDA MOTOR CO., LTD., Tokyo (JP)

(72) Inventors: Masanari HIGUCHI, Saitama (JP); Hidemasa USUI, Saitama (JP); Yosuke YOSHIZAWA, Saitama (JP)

(21) Appl. No.: 18/586,571

(22) Filed: Feb. 26, 2024

(30) Foreign Application Priority Data
Mar. 28, 2023 (JP) 2023-052261

(51) Int. Cl. H01M 10/04; H01M 10/052; H01M 50/204; H01M 50/293; H01M 50/618

(52) U.S. Cl. CPC H01M 10/0468; H01M 50/293; H01M 50/618; H01M 10/052; H01M 50/204

(57) ABSTRACT

A battery module according to an embodiment of the present invention includes a cell stack including a plurality of battery cells that are stacked, a pair of end plates, and a buffer interposed at least between the battery cells or between the battery cells and the end plates. The buffer includes a first region having contact surfaces that are in contact with the battery cells, and a second region that is connected to the first region via a fluid flow path. The first region is filled with a fluid, and the second region includes a fluid filler that is connected to the fluid flow path and is filled with the fluid, and a volume adjuster that is in contact with at least a part of the fluid filler and adjusts a volume of the fluid filler in response to a pressure of the fluid filling the fluid filler.

This application is based on and claims the benefit of priority from Japanese Patent Application No. 2023-052261, filed on 28 Mar. 2023, the content of which is incorporated herein by reference.

### BACKGROUND OF THE INVENTION

### Field of the Invention

The present invention relates to a battery module.

### Related Art

In recent years, research and development of battery modules that contribute to energy efficiency has been carried out in order to ensure many people have access to affordable, reliable, sustainable, and advanced energy. A battery module is produced by combining and modularizing a plurality of battery cells, and generally includes a cell stack formed by stacking the plurality of battery cells, and a pair of end plates disposed at opposite ends of the cell stack in the stacking direction of the cell stack. The battery module is used for applications requiring a large current and a high voltage, such as driving a motor of an electric vehicle and a motor of a hybrid electric vehicle.

For the battery module, it has been under consideration to apply a pressure (restraint force) in the stacking direction of the battery cells by interposing a buffer between battery cells or between the cell stack and the end plates. Known examples of the buffer include a buffer having a deformable chamber and a system for supplying a fluid for deforming the chamber (Patent Document 1), and elastic spring members such as a leaf spring and a fluid spring (Patent Documents 2 and 3).
Patent Document 1: Japanese Unexamined Patent Application, Publication No. 2020-64848
Patent Document 2: Japanese Unexamined Patent Application, Publication No. 2021-96974
Patent Document 3: European Patent Application, Publication No. 3886202

### SUMMARY OF THE INVENTION

For the techniques relating to battery modules, it is a challenge to efficiently apply a uniform and constant pressure (restraint force) to the battery cells. In particular, in a solid-state battery using a solid electrolyte as an electrolyte, it is a challenge to apply a uniform and constant restraint force at a high pressure to the battery cells in order to reduce a contact resistance at an interface between the solid electrolyte and the electrode. On the other hand, in order to increase the electric capacity of a battery cell, a battery cell is being researched, which uses a lithium metal or a metal that forms an alloy with lithium, such as silicon (Si), as a negative electrode active material. However, a battery cell using a metal such as a lithium metal as a negative electrode active material expands significantly during charge and contracts significantly during discharge. In conventional battery modules, the followability of buffers to changes in volume of the battery cells is low, which may make it difficult to adjust the restraint force to be applied to the battery cells in response to changes in the volume of the battery cells.

The present invention has been made to address the above-described disadvantage, and it is an object of the present invention to provide a battery module capable of efficiently applying a uniform and constant pressure to battery cells in response to changes in volume of the battery cells. The present invention also contributes to energy efficiency.

The present inventors have made the present invention based on their findings that the above object can be achieved by filling a fluid into a buffer having contact surfaces that are in contact with battery cells and adjusting the charging amount of the fluid into the buffer in response to a change in volume of the battery cells. Thus, the present invention provides a battery module according to the following first to ninth aspects.

A battery module according to the first aspect includes: a cell stack including a plurality of battery cells that are stacked; a pair of end plates disposed at opposite ends of the cell stack in a stacking direction of the cell stack; and a buffer interposed at least between the battery cells or between the battery cells and the end plates. The buffer includes a first region having contact surfaces that are in contact with the battery cells, and a second region that is connected to the first region via a fluid flow path. The first region is filled with a fluid, and the second region includes a fluid filler that is connected to the fluid flow path and is filled with the fluid, and a volume adjuster that is in contact with at least a part of the fluid filler and adjusts a volume of the fluid filler in response to a pressure of the fluid filling the fluid filler.

In the battery module according to the first aspect, when the battery cells expand, the contact surfaces in the first region that are in contact with the battery cells are pressurized in the stacking direction of the cell stack, and the pressure of the fluid filling the first region and the fluid filler in the second region rises. The volume of the fluid filler is increased by the volume adjuster in the second region in response to the pressure rise of the fluid, whereby a uniform and constant pressure can be efficiently applied to the battery cells even when the battery cells have expanded. When the battery cells contract after expansion and the pressure of the fluid filling the first region and the fluid filler in the second region decreases, the volume of the fluid filler is decreased by the volume adjuster in the second region, whereby the pressure of the fluid can be maintained to be constant. Therefore, the battery module according to the first aspect can efficiently apply a uniform and constant pressure to the battery cells even when the battery cells have contracted after expansion.

The second aspect is an embodiment of the first aspect. In the battery module according to the second aspect, the first region and the second region are disposed adjacently to each other.

In the battery module according to the second aspect, since the first region and the second region of the buffer are adjacent to each other, the miniaturization of the buffers is easily achieved.

The third aspect is an embodiment of the first or second aspect. In the battery module according to the third aspect, the contact surfaces in the first region are made of a material deformable due to the pressurization.

In the battery module according to the third aspect, since the contact surfaces in the first region are made of a material deformable due to pressurization, the followability of the contact surfaces to changes in shape due to expansion or contraction of the battery cells is improved. Therefore, a uniform pressure can be efficiently applied to the battery cells even when the battery cells have contracted after expansion.

The fourth aspect is an embodiment of any one of the first to third aspects. In the battery module according to the fourth aspect, the fluid is mineral oil or an inert gas.

In the battery module according to the fourth aspect, since the fluid is mineral oil or an inert gas and a change in fluidity due to temperature is small, a uniform and constant pressure can be applied to the battery cells in a wide temperature range.

The fifth aspect is an embodiment of the fourth aspect. In the battery module according to the fifth aspect, the fluid is an inert gas and the second region is a chamber tank.

In the battery module according to the fifth aspect, since the second region is a chamber tank, and a pressure applied to the fluid via the contact surfaces can be efficiently absorbed, a constant pressure can be applied to the battery cells.

The sixth aspect is an embodiment of the fourth aspect. In the battery module according to the sixth aspect, the fluid is mineral oil and the second region is an accumulator.

In the battery module according to the sixth aspect, since the second region is an accumulator, the pressure of the fluid can be adjusted with high accuracy.

The seventh aspect is an embodiment of the sixth aspect. In the battery module according to the seventh aspect, the accumulator is a metal leaf spring type accumulator using a metal leaf spring.

In the battery module according to the seventh aspect, since the second region (accumulator) is a metal leaf spring type accumulator, the pressure of the fluid can be adjusted with higher accuracy.

A battery module according to the eighth aspect includes: a cell stack including a plurality of battery cells that are stacked; a pair of end plates disposed at opposite ends of the cell stack in a stacking direction of the cell stack; and a buffer interposed at least between the battery cells or between the battery cells and the end plates. The buffer includes a first region having contact surfaces that are in contact with the battery cells, a fluid reservoir that is connected to the first region, and a second region that is connected to the fluid reservoir via a pipeline. The first region and the fluid reservoir are filled with a fluid, and the second region includes a fluid filler that is connected to the pipeline and is filled with the fluid, and a volume adjuster that is in contact with at least a part of the fluid filler and adjusts a volume of the fluid filler in response to a pressure of the fluid filling the fluid filler.

In the battery module according to the eighth aspect, when the battery cells expand, the contact surfaces in the first region that are in contact with the battery cells are pressurized in the stacking direction of the cell stack, and the pressure of the fluid filling the first region and the fluid reservoir rises. The volume of the fluid filler is increased by the volume adjuster in the second region in response to the pressure rise of the fluid, whereby a uniform and constant pressure can be efficiently applied to the battery cells even when the battery cells have expanded. When the battery cells contract after expansion and the pressure of the fluid filling the first region and the fluid reservoir decreases, the volume of the fluid filler is decreased by the volume adjuster in the second region, whereby the pressure of the fluid can be maintained to be constant. Therefore, the battery module according to the eighth aspect can efficiently apply a uniform and constant pressure to the battery cells even when the battery cells have contracted after expansion.

The ninth aspect is an embodiment of the eighth aspect. In the battery module according to the ninth aspect, the second region is disposed on a surface opposite to the cell stack side of one of the end plates.

In the battery module according to the ninth aspect, since the second region is disposed on a surface opposite to the cell stack side of one of the end plates, the structure of the battery module can be made compact.

The tenth aspect is an embodiment of the eighth or ninth aspect. In the battery module according to the tenth aspect, the fluid is mineral oil and the second region is an accumulator.

In the battery module according to the tenth aspect, since the second region is an accumulator, the pressure of the fluid can be adjusted with higher accuracy.

The eleventh aspect is an embodiment of the tenth aspect. In the battery module according to the eleventh aspect, the second region is a constant-load spiral spring type accumulator using a constant-load spiral spring.

In the battery module according to the eleventh aspect, since the second region (accumulator) is a constant-load spiral spring type accumulator, the pressure of the fluid can be adjusted with higher accuracy.

According to embodiments of the present invention, it is possible to provide a battery module capable of applying a uniform and constant pressure to battery cells even when the battery cells partially expand or contract.

### BRIEF DESCRIPTION OF THE DRAWINGS

FIG. 1 is a cross-sectional view of a battery module according to a first embodiment of the present invention;

FIG. 2 is a cross-sectional view of a battery cell that can be used in the battery module according to the first embodiment of the present invention;

FIG. 3 is a plan view of a buffer that is used in the battery module according to the first embodiment of the present invention;

FIG. 4 is a cross-sectional view taken along line IV-IV in FIG. 3;

FIG. 5 is a cross-sectional view taken along line V-V in FIG. 3;

FIG. 6 is a cross-sectional view taken along line VI-VI in FIG. 4;

FIG. 7A is a cross-sectional view illustrating a state in which a pressure is applied to contact surfaces of a buffer that is used in the battery module according to the first embodiment of the present invention;

FIG. 7B is a cross-sectional view illustrating a state in which a pressure is applied to the contact surfaces of the buffer that is used in the battery module according to the first embodiment of the present invention;

FIG. 8 is a cross-sectional view of a battery module according to a second embodiment of the present invention;

FIG. 9 is a cross-sectional view of a first region of a buffer that is used in the battery module according to the second embodiment of the present invention;

FIG. 10 is a plan view of a second region of the buffer that is used in the battery module according to the second embodiment of the present invention; and

FIG. 11 is a cross-sectional view taken along line XI-XI in FIG. 10.

### DETAILED DESCRIPTION OF THE INVENTION

Embodiments of the present invention will be described below with reference to the drawings. It should be noted that the following embodiments exemplify the present invention, and are not intended to limit the present invention.

### First Embodiment

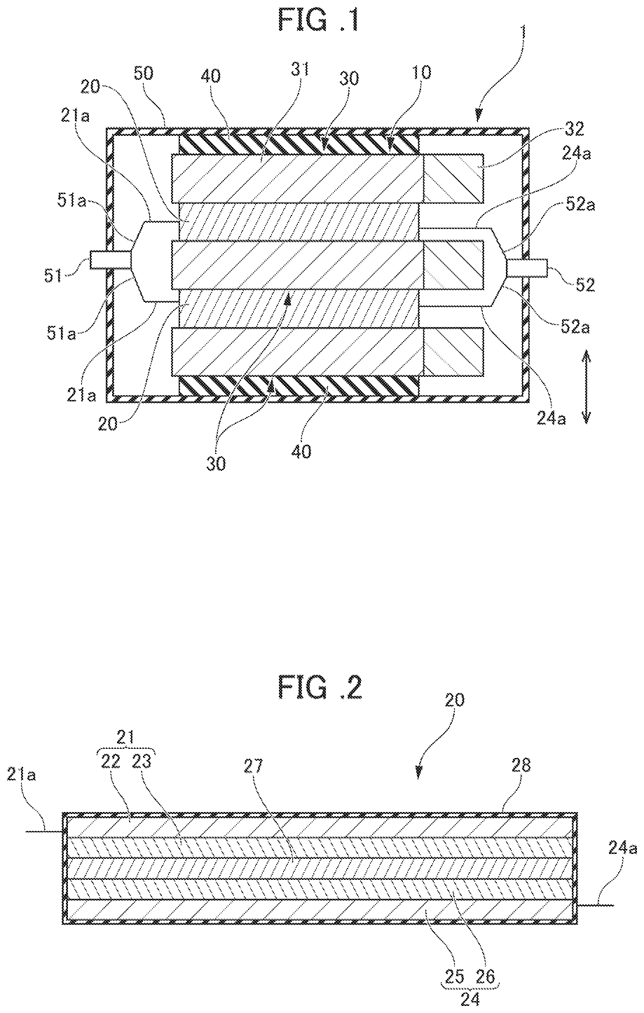

As illustrated in FIGS. 1 and 2, a battery module 1 according to the present embodiment includes a cell stack 10. A pair of end plates 40 are disposed at the opposite ends of the cell stack 10 in the stacking direction of the cell stack 10. The cell stack 10 is a stack including a plurality of battery cells 20 and buffers 30 that are stacked in the stacking direction indicated by the arrow in FIG. 1. The buffers 30 are interposed between the battery cells 20 and between the battery cell 20 and each end plate 40. The cell stack 10 and the end plates 40 are housed in a case 50. The case 50 has a negative electrode tab 51 and a positive electrode tab 52. The negative electrode tab 51 is connected to negative electrode terminals 21a of the battery cells 20 via lead wires 51a. The positive electrode tab 52 is connected to positive electrode terminals 24a of the battery cells 20 via lead wires 52a.

### (Battery Cell)

As illustrated in FIG. 2, each battery cell 20 is a solid-state battery in which an electrode laminate in which a negative electrode layer 21 and a positive electrode layer 24 are laminated via a solid electrolyte layer 27 is housed in an exterior package 28. The laminating direction in which the electrode layers (negative electrode layer 21 and positive electrode layer 24) of the battery cell 20 are laminated is the same as the stacking direction of the cell stack 10. Therefore, when the negative electrode layer 21 or the positive electrode layer 24 expands or contracts due to the charge/discharge of the battery cell 20, the battery cell 20 expands or contracts in the stacking direction of the cell stack 10. Although the battery cell 20 illustrated in FIG. 2 includes one electrode laminate housed in the exterior package 28, a plurality of electrode laminates may be housed in the exterior package 28.

The negative electrode layer 21 includes a negative electrode current collector 22 and a negative electrode active material layer 23. The negative electrode active material layer 23 is disposed adjacent to the solid electrolyte layer 27. The negative electrode current collector 22 is connected to the negative electrode terminal 21a.

The negative electrode current collector 22 is not particularly limited as long as it has a function of collecting electricity of the negative electrode layer 21, and examples of the material for the negative electrode current collector 22 include nickel, copper, and stainless steel. Examples of the shape of the negative electrode current collector include a foil shape and a plate shape.

The negative electrode active material layer 23 contains a negative electrode active material as an essential component. The negative electrode active material is not particularly limited as long as it can occlude and release a charge transfer medium. For example, in the case of a lithium ion battery, example of the negative electrode active material include a lithium transition metal oxide such as lithium titanate (Li₄Ti₅O₁₂), a transition metal oxide such as TiO₂, Nb₂O₃, and WO₃, a metal sulfide, a metal nitride, a carbon material such as graphite, soft carbon, and hard carbon, metallic lithium, and a metal that forms an alloy with lithium. Examples of the metal that forms an alloy with lithium include Mg, Si, Ag, In, Ge, Sn, Pb, Al, and Zn. The negative electrode active material may be in the form of powder or a thin film. The negative electrode active material layer 23 may contain a conductive auxiliary for improving conductivity, and a binder, in addition to the negative electrode active material. As the conductive auxiliary and the binder, materials generally used in solid-state batteries can be used. When the negative electrode active material layer 23 is metallic lithium, the negative electrode active material layer 23 may not be provided in an initial state of the battery cell 20 or in a fully discharged state of the battery cell 20.

The positive electrode layer 24 includes a positive electrode current collector 25 and a positive electrode active material layer 26. The positive electrode active material layer 26 is disposed adjacent to the solid electrolyte layer 27. The positive electrode current collector 25 is connected to the positive electrode terminal 24a.

The positive electrode current collector 25 is not particularly limited as long as it has a function of collecting electricity of the positive electrode layer 24, and examples of the material for the positive electrode current collector 25 include aluminum, aluminum alloy, stainless steel, nickel, iron, and titanium, among which aluminum, aluminum alloy, and stainless steel are preferred. Examples of the shape of the positive electrode current collector 25 include a foil shape and a plate shape.

The positive electrode active material layer 26 contains at least a positive electrode active material. The positive electrode active material contained in the positive electrode active material layer 26 is not particularly limited and may be the same as that used for a positive electrode layer of a general solid-state battery. In the case of a lithium ion battery, examples of the positive electrode active material include a layered active material containing lithium, a spinel active material, and an olivine active material. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), Li—Mn spinel represented by Li₁₊ₓMn_{2-x-y}MyO₄ (where X+y=2, and M is at least one selected from Al, Mg, Co, Fe, Ni, or Zn), lithium titanate (an oxide containing Li and Ti), and lithium metal phosphate (LiMPO₄, where M is at least one selected from Fe, Mn, Co, or Ni). The positive electrode active material layer 26 may optionally contain a solid electrolyte, from the viewpoint of improving charge transfer medium conductivity. The positive electrode active material layer 26 may further contain a binder, a conductive auxiliary, and the like. As these substances, those generally used in solid-state batteries can be used.

The solid electrolyte layer 27 contains at least a solid electrolyte material. The charge transfer medium is conducted between the positive electrode active material and the negative electrode active material through the solid electrolyte material contained in the solid electrolyte layer 27. The solid electrolyte material is not particularly limited as long as it has charge transfer medium conductivity, i.e., ion conductivity, and examples thereof include a sulfide solid electrolyte material, an oxide solid electrolyte material, a nitride solid electrolyte material, and a halide solid electrolyte material. Examples of the sulfide solid electrolyte material include Li₂S—P₂S₅ and Li₂S—P₂S₅—LiI in the case of a lithium ion battery, for example. The description of “Li₂S—P₂S₅” means a sulfide solid electrolyte material including a raw material composition containing Li₂S and P₂S₅. Examples of the oxide solid electrolyte material include a NASICON type solid electrolyte, a garnet type solid electrolyte, and a perovskite type solid electrolyte in the case of a lithium ion battery, for example. Examples of the NASICON type solid electrolyte include oxides containing Li, Al, Ti, P, and O (e.g., Li_{1.5}Al_{0.5}Ti_{1.5}(PO₄)₃). Examples of the garnet type solid electrolyte include oxides containing Li, La, Zr, and O (e.g., Li₇La₃Zr₂O₁₂). Examples of the perovskite type solid electrolyte include oxides containing Li, La, Ti, and O (e.g., LiLaTiO₃).

The exterior package 28 is not particularly limited as long as it can house the electrode laminate, and a laminate film can be used as the material for the exterior package 28, for example. The laminate film has a multilayer structure in which a layer of a heat-sealable resin such as polyolefin or the like is laminated on a surface of a metal layer made of aluminum, stainless steel (SUS), or the like. For example, the laminate film may include, in addition to the foregoing, a layer made of polyamide such as nylon or the like, a layer made of polyester such as polyethylene terephthalate or the like, an adhesive layer made of an arbitrary laminate adhesive or the like.

### (Buffer)

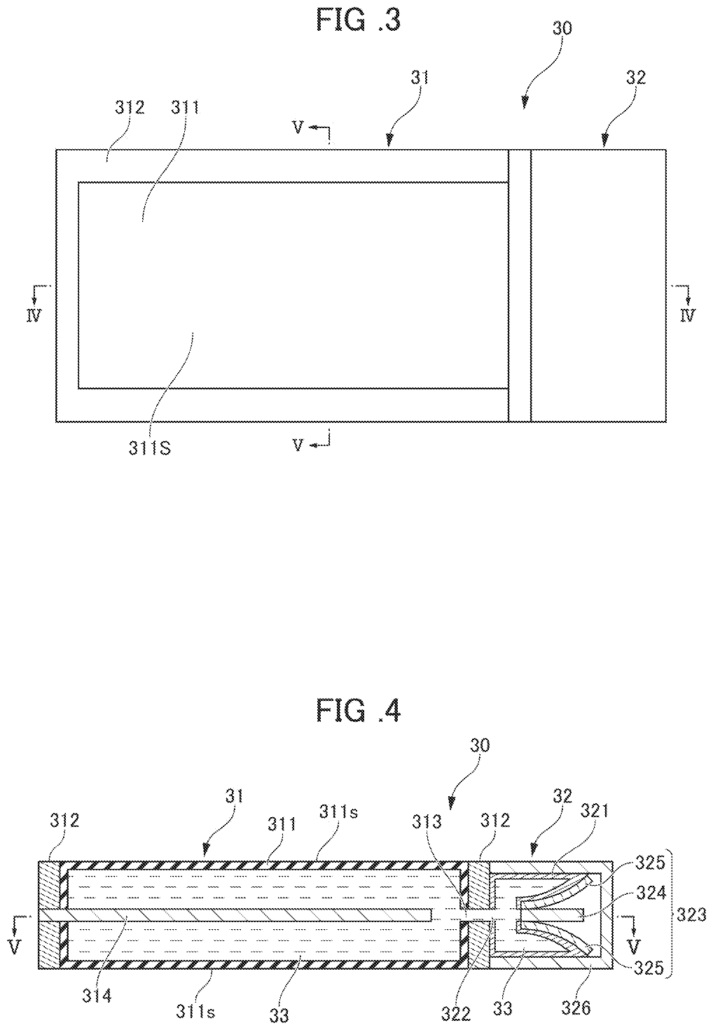

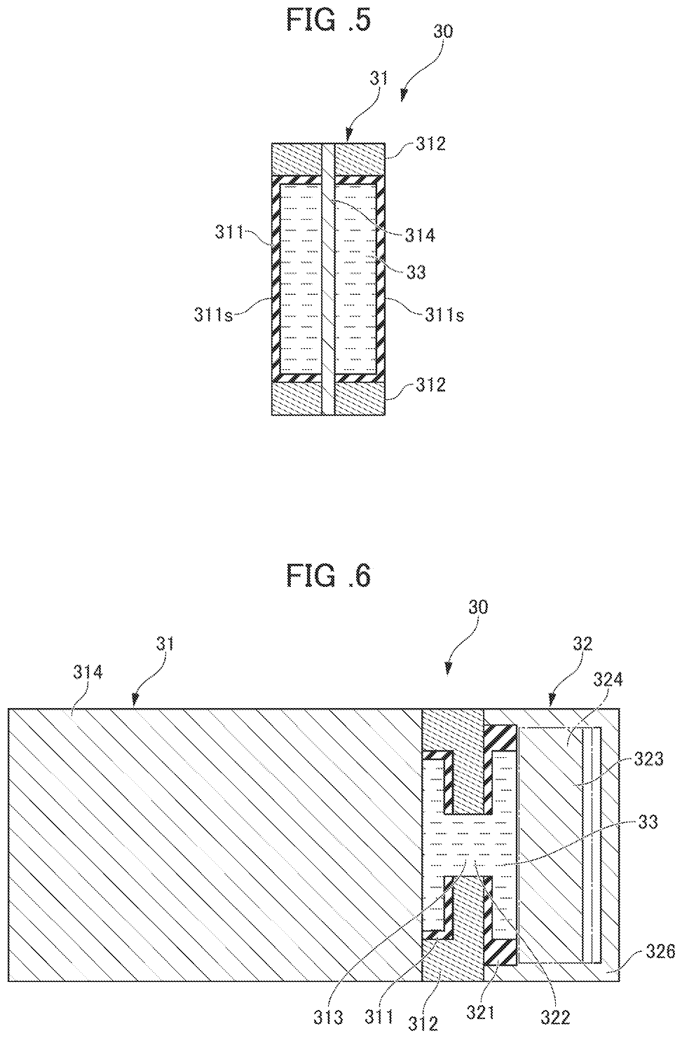

The buffer 30 has an action of uniformizing a surface pressure applied to the battery cells 20. The surface pressure applied to the battery cell 20 is, for example, 1 to 5 MPa or may be 1 to 2 MPa. As illustrated in FIGS. 3 to 5, the buffer 30 has a first region 31 and a second region 32. The first region 31 and the second region 32 are disposed adjacently to each other to be integrally connected to each other.

The first region 31 functions as a pressure uniformizer for uniformizing a surface pressure. The first region 31 is a hollow member having a substantially rectangular parallelepiped shape, and has a first fluid filler 311, the interior of which is filled with a fluid 33. The first fluid filler 311 is made of a material deformable due to the pressurization, for example. Examples of the material deformable due to the pressurization include a rubber film. Each of an upper surface and a lower surface of the first fluid filler 311 serves as a contact surface 311s that is in contact with the battery cell 20. The contact surface 311s is a surface that is in contact with the battery cell 20 or the end plate 40. Each side surface of the first fluid filler 311 is provided with a first outer frame 312. The first outer frame 312 acts as a protective material that protects the first fluid filler 311 so that the first fluid filler 311 is prevented from being excessively crushed by the pressure.

In the first fluid filler 311 and the first outer frames 312, a first region opening 313 is provided in an end to which the second region 32 is connected. A base plate 314 is disposed inside the first fluid filler 311, the base plate 314 extending from an end on a side opposite to the first region opening 313 to the proximity of the first region opening 313. The base plate 314 has a function of controlling a flow of the fluid 33 when the fluid 33 flows between the first fluid filler 311 and a second fluid filler 321 by a pressure applied to the contact surfaces 311s.

The second region 32 functions as a pressure adjuster for adjusting a pressure of the fluid 33 filling the first fluid filler 311. In the present embodiment, a metal leaf spring type accumulator is used as the second region 32. The second region 32 comprises the second fluid filler 321 and a volume adjuster 323. The second fluid filler 321 and the volume adjuster 323 are housed in a case 326. The second fluid filler 321 is filled with the fluid 33. The second fluid filler 321 has a second region opening 322 that is connected to the first region opening 313. The first region opening 313 and the second region opening 322 form a fluid flow path that connects the first fluid filler 311 and the second fluid filler 321. The second fluid filler 321 may have elasticity.

The volume adjuster 323 is disposed on a side opposite to the second region opening 322. The volume adjuster 323 has a support plate 324, and metal leaf springs 325 that are connected to upper and lower surfaces of the support plate 324. As illustrated in FIG. 6, the support plate 324 is fixed by the case 326. The support plate 324 may be bonded to the case 326 or may be integrated with the case 326. As the metal leaf springs 325, various metal leaf springs used as metal leaf springs for the metal leaf spring type accumulator can be used.

The metal leaf springs 325 and the second fluid filler 321 contact each other. When the pressure of the fluid 33 filling the second fluid filler 321 rises, the metal leaf springs 325 bend in a direction approaching the support plate 324, whereby the volume of the second fluid filler 321 increases. When the pressure of the fluid 33 filling the second fluid filler 321 decreases, the metal leaf springs 325 bend in a direction away from the support plate 324, whereby the volume of the second fluid filler 321 decreases.

As the fluid 33, a liquid and gas can be used. As the liquid, mineral oil can be used. As the gas, for example, an inert gas can be used. In the present embodiment, the mineral oil is used.

### (End Plates)

The end plates 40 act to restrain the cell stack 10 in the stacking direction. The surface pressure applied to the cell stack 10 by the buffers 30 can be adjusted by means of the restraint force of the end plates 40. The material for the end plates 40 is not particularly limited, and various materials used as the end plates for battery modules can be used.

### (Case)

The case 50 houses the cell stack 10 and the end plates 40. The material for the case 50 is not particularly limited, and various materials used as battery module cases can be employed as the material for the case 50.

### (Operation of Buffer)

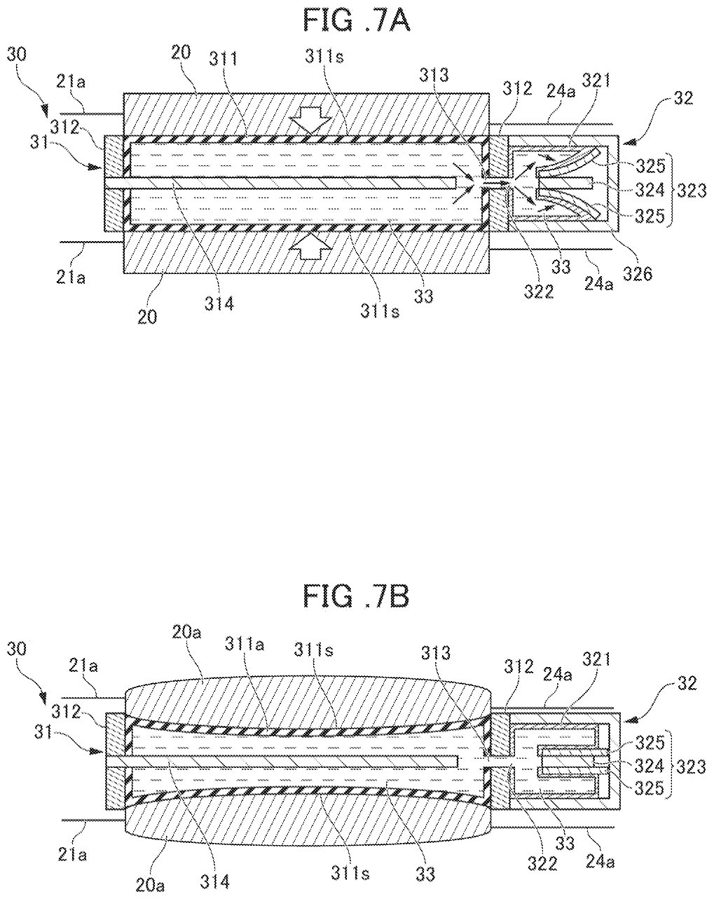

Next, an operation that the buffers 30 perform when the battery cells 20 in the battery module 1 expand will be described with reference to FIGS. 7A and 7B. As illustrated in FIG. 7A, when the battery cells 20 expand, the contact surfaces 311s of the first fluid filler 311 that are in contact with the battery cells 20 are pressurized in the stacking direction of the cell stack (a direction indicated by a hollow arrow in FIG. 7A), and the pressure of the fluid 33 rises. When the pressure of the fluid 33 filling the second fluid filler 321 rises, the metal leaf springs 325 bend in a direction approaching the support plate 324, and the volume of the second fluid filler 321 increases. An increase in the volume of the second fluid filler 321 causes the fluid 33 to flow in a direction (a direction indicated by a black arrow in FIG. 7A) from the first fluid filler 311 toward the second fluid filler 321 through the fluid flow path (the first fluid filler 311 and the second fluid filler 321).

When the fluid 33 flows from the first fluid filler 311 to the second fluid filler 321, the volume of the fluid 33 in the first fluid filler 311 decreases. This causes the contact surfaces 311s of a first fluid filler 311a to be deformed to maintain high adhesion to surfaces of the expanded battery cells 20a, as illustrated in FIG. 7B.

In the battery module 1 of the present embodiment having the configuration described above, when the battery cells 20 expand, the contact surfaces 311s of the first fluid filler 311 in the first region 31 that are in contact with the battery cells 20 are pressurized in the stacking direction of the cell stack 10, and the pressure of the fluid 33 filling the first fluid filler 311 and the second fluid filler 321 rises. The volume of the second fluid filler 321 is increased by the volume adjuster 323 in the second region 32 in response to the pressure rise of the fluid 33, whereby a uniform and constant pressure can be efficiently applied to the battery cells 20 even when the battery cells 20 have expanded. When the battery cells 20 contract after expansion and the pressure of the fluid 33 filling the first fluid filler 311 and the second fluid filler 321 decreases, the volume of the second fluid filler 321 is decreased by the volume adjuster in the second region 32, whereby the pressure of the fluid 33 can be maintained to be constant. Therefore, the battery module 1 of the present embodiment can efficiently apply a uniform and constant pressure to the battery cells 20 even when the battery cells 20 have contracted after expansion.

In the battery module 1 of the present embodiment, since the first region 31 and the second region 32 of the buffer 30 are disposed adjacently to each other, the miniaturization of the buffers 30 is easily achieved. In the battery module 1 of the present embodiment, since the fluid 33 in each buffer 30 is mineral oil and a change in fluidity due to temperature is small, a uniform and constant pressure can be applied to the battery cells 20 in a wide temperature range. Furthermore, in the battery module 1 of the present embodiment, since the second region 32 is a metal leaf spring type accumulator, the pressure of the fluid 33 can be adjusted with high accuracy.

### Second Embodiment

### (Battery Module)

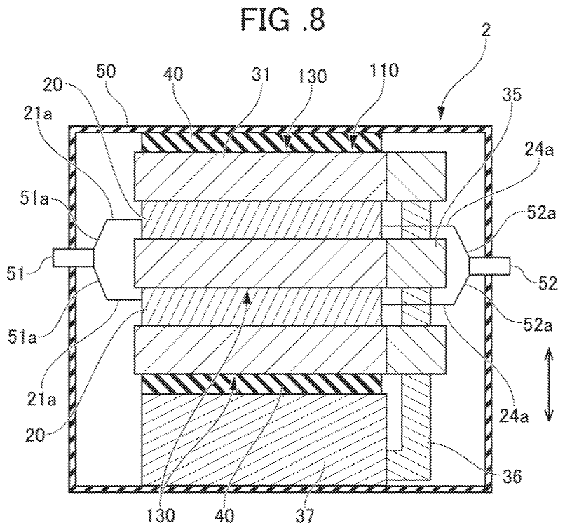

As illustrated in FIG. 8, a battery module 2 according to a second embodiment includes buffers 130 interposed between battery cells 20 forming a cell stack 110 and between the battery cell 20 and end plates 40. The battery module 2 of the present embodiment has the same configuration as that of the battery module 1 of the first embodiment, except for the configuration of the buffer 130. Therefore, in the description of the second embodiment, the same components as those of the first embodiment are denoted by the same reference signs, and the description thereof will be omitted.

### (Buffer)

Each buffer 130 includes a first region 31, a fluid reservoir 35 that is connected to the first region 31, a pipeline 36 that is connected to the fluid reservoir 35, and a second region 37 that is connected to the pipeline 36. The second region 37 is disposed on a lower surface of the end plate 40 on a lower side in the stacking direction of the cell stack 110. The first region 31 has the same configuration as that of the buffer 30 in the battery module 1 of the first embodiment.

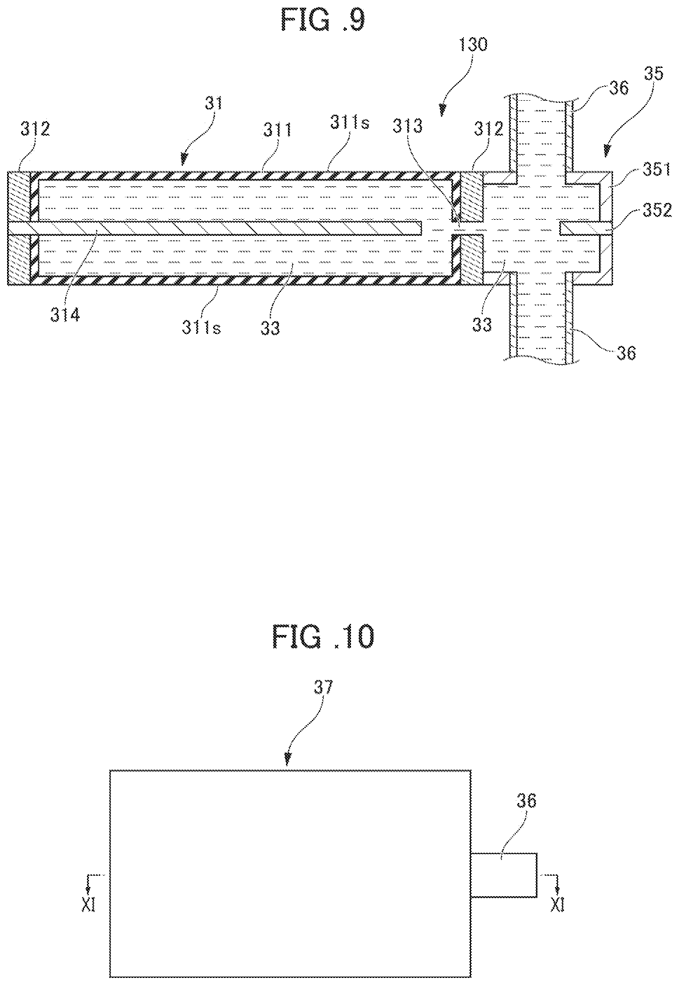

The fluid reservoir 35 acts as a fluid reserving tank for supplying, to the pipeline 36, the fluid 33 having flowed in from the first region 31 during expansion of the battery cells 20, and supplying, to the first region 31, the fluid 33 having flowed in from the pipeline 36 during contraction of the battery cells 20. As illustrated in FIG. 9, the fluid reservoir 35 has a fluid reserving container 351 and a rectifying plate 352. The rectifying plate 352 has an action of facilitating supply of the fluid 33 having flowed in from the first region 31 to the pipeline 36 and facilitating a flow of the fluid 33 having flowed in from the pipeline 36 into the first region 31. The fluid 33 is, for example, a liquid (mineral oil).

The pipeline 36 is a pipe for supplying the fluid 33 from the fluid reservoir 35 to the second region 37 or from the second region 37 to the fluid reservoir 35.

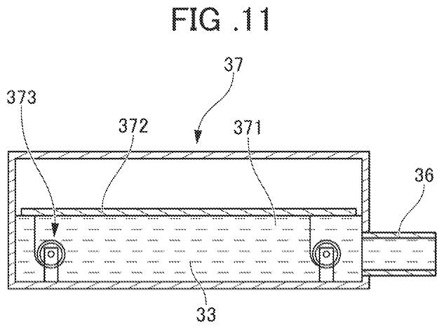

As illustrated in FIGS. 10 and 11, the second region 37 has a fluid filler 371 that is connected to the pipeline 36 and is filled with the fluid 33, a floating plate 372 that is disposed on an upper surface of the fluid 33, and constant-load spiral springs 373 that are connected to the floating plate 372. That is, the second region 37 serves as a constant-load spiral spring type accumulator that has the floating plate 372 and the constant-load spiral springs 373 as a volume adjuster. In the constant-load spiral spring type accumulator, the floating plate is pushed upward by the fluid 33 (liquid) during expansion of the battery cells 20, whereby the volume of the fluid filler 371 is increased. The floating plate is retracted downward by the constant-load spiral springs 373 during contraction of the battery cells 20, whereby the volume of the fluid filler 371 is decreased. As the second region 37, an accumulator having displacement dependence, such as a coil spring type accumulator and a leaf spring type accumulator, may be used. The constant-load spiral spring type accumulator is preferred in view of more easily applying a constant pressure to the battery cells 20 than the accumulators having displacement dependence, regardless of expansion amount of the battery cells 20.

In the battery module 2 of the present embodiment, when the battery cells 20 expand, the volume of the fluid filler 371 in the second region 37 can be increased, and when the battery cells 20 contract, the volume of the fluid filler 371 in the second region 37 can be decreased. Therefore, the battery module 2 of the present embodiment can efficiently apply a uniform and constant pressure to the battery cells 20 even when the battery cells 20 have contracted after expansion. In the battery module 2 of the present embodiment, since the second region 37 is disposed on a lower surface of the end plate 40 on a lower side in the stacking direction of the cell stack 110, the structure of the battery module 2 can be made compact.

In the foregoing, preferred embodiments of the present invention have been described. However, it should be noted that the present invention is not limited to the embodiments described above, and can be modified as appropriate.

In the above embodiments, the battery cell 20 is described as a solid-state battery, but the battery cell 20 is not limited thereto. The battery cell 20 may be, for example, a liquid-type battery including an organic electrolytic solution as an electrolyte, or a polymer battery including a high polymer gel (polymer).

In the above embodiments, the buffers 30, 130 are interposed between the battery cells 20 and between the battery cells 20 and the end plates 40, but the positions of the buffers 30, 130 are not limited thereto. It is only necessary for the buffers 30, 130 to be interposed at least between the battery cells 20 or between the battery cell 20 and the end plate 40.

### EXPLANATION OF REFERENCE NUMERALS

1, 2: Battery module
10: Cell stack
20, 20a: Battery cell
21: Negative electrode layer
21a: Negative electrode terminal
22: Negative electrode current collector
23: Negative electrode active material layer
24: Positive electrode layer
24a: Positive electrode terminal
25: Positive electrode current collector
26: Positive electrode active material layer
27: Solid electrolyte layer
28: Exterior package
30, 130: Buffer
31: First region
32: Second region
33: Fluid
35: Fluid reservoir
36: Pipeline
37: Second region
40: End Plate
50: Case
51: Negative electrode tab
51a: Lead wire
52: Positive electrode tab
52a: Lead wire
110: Cell stack
311, 311a: First fluid filler
311s: Contact surface
312: First outer frame
313: First region opening
314: Base plate
321: Second fluid filler
322: Second region opening
323: Volume adjuster
324: Support plate
326: Case
351: Fluid reserving container
352: Rectifying plate
371: Fluid filler
372: Floating plate
373: Constant-load spiral spring

What is claimed is:

1. A battery module, comprising:
a cell stack including a plurality of battery cells that are stacked;
a pair of end plates disposed at opposite ends of the cell stack in a stacking direction of the cell stack; and
a buffer interposed at least between the battery cells or between the battery cells and the end plates,
the buffer comprising a first region having contact surfaces that are in contact with the battery cells, and a second region that is connected to the first region via a fluid flow path,
wherein the first region is filled with a fluid, and the second region includes a fluid filler that is connected to the fluid flow path and is filled with the fluid, and a volume adjuster that is in contact with at least a part of the fluid filler and adjusts a volume of the fluid filler in response to a pressure of the fluid filling the fluid filler.

2. The battery module according to claim 1, wherein the first region and the second region are disposed adjacently to each other.

3. The battery module according to claim 1, wherein the contact surfaces in the first region are made of a material deformable due to pressurization.

4. The battery module according to claim 1, wherein the fluid is mineral oil or an inert gas.

5. The battery module according to claim 4, wherein the fluid is an inert gas and the second region is a chamber tank.

6. The battery module according to claim 4, wherein the fluid is mineral oil and the second region is an accumulator.

7. The battery module according to claim 6, wherein the accumulator is a metal leaf spring type accumulator using a metal leaf spring.

8. A battery module, comprising:
a cell stack including a plurality of battery cells that are stacked;
a pair of end plates disposed at opposite ends of the cell stack in a stacking direction of the cell stack; and
a buffer interposed at least between the battery cells or between the battery cells and the end plates,
the buffer comprising a first region having contact surfaces that are in contact with the battery cells, a fluid reservoir that is connected to the first region, and a second region that is connected to the fluid reservoir via a pipeline,
wherein the first region and the fluid reservoir are filled with a fluid, and the second region includes a fluid filler that is connected to the pipeline and is filled with the fluid, and a volume adjuster that is in contact with at least a part of the fluid filler and adjusts a volume of the fluid filler in response to a pressure of the fluid filling the fluid filler.

9. The battery module according to claim 8, wherein the second region is disposed on a surface opposite to the cell stack side of one of the end plates.

10. The battery module according to claim 8, wherein the fluid is mineral oil and the second region is an accumulator.

11. The battery module according to claim 10, wherein the second region is a constant-load spiral spring type accumulator using a constant-load spiral spring.
